(19) United States
(12) Patent Application Publication
(10) Pub. No.: US 2025/0389740 A1
(43) Pub. Date: Dec. 25, 2025

(54) SAMPLE ANALYSIS SYSTEM WITH PHASE-BASED TARGET IDENTIFICATION AND EXTRACTION

(71) Applicant: DenTM LLC, Somerville, MA (US)

(72) Inventor: Thamer Y. Marghalani, Jeddah (SA)

(21) Appl. No.: 18/751,675

(22) Filed: Jun. 24, 2024

(51) Int. Cl. G01N 35/00; G01N 30/06; G01N 35/04

(52) U.S. Cl. CPC G01N 35/00732; G01N 30/06; G01N 2035/0437

(57) ABSTRACT

Embodiments of the present disclosure relate to an automated and remote system for collecting and analyzing one or more samples over time. The system includes an analysis module that performs a cycle of operations, which includes selecting a phase analyte of the sample in a phase module, identifying a target product from the phase analyte in a component module, and extracting the target product from the phase analyte in one or more extraction modules. The system also includes a device that interfaces with the analysis module and includes a processor that activates one or more of the extraction modules during the cycle of operations. The one or more extraction modules are configured to reduce the phase analyte purity to a predetermined level during the cycle of operations.

### TECHNICAL FIELD

The present disclosure relates to remote and automated maintenance, processing, and recovery of sedimentary deposits in extreme environments.

### BACKGROUND

The vast potential of renewable energy has driven the widespread adoption of photovoltaic (PV) solar panels. However, in extreme environments their efficient power generation can be impacted by the accumulation of windblown matter, including minerals, loess (fine-grained windblown sediment), solar wind deposits, and airborne chemicals. While seemingly inconsequential, these deposits can significantly reduce panel efficiency by obscuring sunlight and altering thermal properties. Moreover, the composition and behavior of this windblown matter are of significant scientific interest due to its diverse origins and environmental implications.

Understanding the presence of specific minerals and chemicals in windblown matter can indicate anthropogenic pollution sources, monitor the spread of harmful airborne contaminants, and contribute to understanding their impact on human health and ecosystems.

Studying windblown, sedimented or deposited matter provides valuable insight for understanding dust transport on other planets, moons, and space dusts shedding light on their geological history and potential for sustaining life. Windblown deposits sometimes contain rare or valuable minerals or living and non-living matter, leading to potential applications in mineral exploration and recovery. Additionally, loess deposits are often fertile soils supporting agriculture, forestry, space and other scientific explorations.

While windblown matter poses a challenge to solar panel efficiency, understanding its composition and deposition patterns can inform the development of improved panel designs and cleaning strategies, thereby optimizing PV energy production. Therefore, a comprehensive understanding of windblown matter and its impact on various fields necessitates efficient methods for its collection, detection, and analysis. Embodiments herein disclosed address the need by providing a novel device specifically designed to extract and purify windblown samples from PV solar panels or other collected mixed multiphases materials for further scientific exploration and practical applications.

### SUMMARY

Embodiments of the present disclosure provide a system for analyzing a sample of material collected from the surface of a solar panel or other collections methods of deposited, sedimented, and rocky multiphasic matters and materials. Other sediments, deposits, and collected materials that contained mixed multiphases and matter states can be processed utilizing this technology. The system includes an analysis module that performs a cycle of operations, which includes selecting a phase analyte of the sample in a phase module, identifying a target product from the phase analyte in a component module, and extracting the target product from the phase analyte using one or more extraction modules. The system also includes a device that interfaces with the analysis module and includes a processor that activates one or more of the extraction modules during the cycle of operations. The one or more extraction modules are configured to reduce the phase analyte purity to a predetermined level during the cycle of operations.

In some aspects, the techniques described herein relate to a system for analysis of a sample including: an analysis module configured to perform a cycle of operations including: (a) selecting a phase analyte of the sample in a phase module, (b) identifying a target product from the phase analyte in a component module, and (c) extracting the target product from the phase analyte in one or more extraction modules; a device configured to interface with the analysis module and including a processor configured to activate one or more of extraction modules during a cycle of operations a)-c), wherein the one or more extraction modules are configured to reduce phase analyte purity to during the cycle of operations a)-c).

In some aspects, the techniques described herein relate to a system wherein the processor is configured to activate the component module, wherein the component module is configured to identify a chemical component of the target product.

In some aspects, the techniques described herein relate to a system wherein the component module includes a pressure gradient tube, and is configured to control transport of the chemical component from a collection chamber to a chemical identification component.

In some aspects, the techniques described herein relate to a system wherein the processor is configured to receive a feedback signal from the chemical identification component, and adjust the component module to control transport to a second chemical identification component based on the feedback signal.

In some aspects, the techniques described herein relate to a system wherein the processor is configured to activate the phase module, wherein the phase module is configured to identify a thermodynamic phase of the sample.

In some aspects, the techniques described herein relate to a system wherein the processor is configured to receive a feedback signal from the phase module and activate the one or more extraction modules based on the feedback signal.

In some aspects, the techniques described herein relate to a system wherein the processor is configured to receive a feedback signal from the analysis module and activate a recycling module configured to control transport of the target product to a storage component based on the feedback signal from the analysis module.

In some aspects, the techniques described herein relate to a system wherein the device further includes a photovoltaic cleaning module including a sensor used to determine whether the external plane of a photovoltaic panel has above a certain threshold of dust or other debris, a scrubber configured to move a across the external facing plane of a photovoltaic panel across one or more axis, a fluid delivery element located at the scrubber, and a sample collection element, wherein the sample collection element is configured to communicate with the analysis module to control the analysis of the sample (and a container to receive the sample) to be analyzed.

In some aspects, the techniques described herein relate to a system for remotely and automatically analyzing a mixed phase sample including: a distribution component including a spectrometer module, wherein the distribution component is configured to accommodate the mixed phase sample and configured to transmit a signal to a central processing unit, wherein the central processing unit is configured to send an operational signal to the distribution component based on the signal from the spectrometer module, wherein the distribution component is configured to transfer the mixed phase sample from a sample inlet to a filtration component based on the operational signal.

In some aspects, the techniques described herein relate to a system, wherein the filtration component is configured to communicate with a sample reservoir component configured to accommodate at a least a first portion of the mixed phase sample, the filtration component is configured to communicate with a separation column at least a second portion of the mixed phase sample.

In some aspects, the techniques described herein relate to a system, wherein the distribution component further includes an ultrasonic component configured to receive a feedback signal from the filtration component and activate an ultrasonic extraction module in the extraction based on the feedback signal from the filtration component.

In some aspects, the techniques described herein relate to a system, further including a purification module, wherein the feedback signal received by the central processing unit from the spectrometer module controls operation of the purification module which is configured to communicate with the sample reservoir component.

In some aspects, the techniques described herein relate to a system, wherein the distribution component further includes a rotatable selection component configured to communicate with the separation column further configured to produce a feedback signal, and based on the feedback signal from the separation column, a rotatable selection column selectively rotates a rotatable portion of the distribution component, wherein the second portion of the mixed phase sample is communicated from the separation column to the rotatable selection component.

In some aspects, the techniques described herein relate to a system, wherein the rotatable selection component further includes an analyzer, the analyzer being configured to isolate a specific component from the second portion of the mixed phase sample, and communicate the specific component to a second reservoir component.

In some aspects, the techniques described herein relate to a system, wherein the analyzer is further configured to communicate a remainder of the mixed phase sample to the filtration component via the distribution component further including a feedback loop configured to communicate the remainder of the mixed phase sample from the analyzer to the filtration component.

In some aspects, the techniques described herein relate to a method for purifying a mixed phase sample including: providing a central processing unit configured to communicate and control a distribution component including: a sample inlet, a spectrometer, and a filtration component, a sample reservoir, and a separation column; transferring the mixed phase sample from the sample inlet to the spectrometer; analyzing the mixed phase sample via the spectrometer; filtering and separating the mixed phase sample via the filtration component; and communicating a first portion of the mixed phase sample to the sample reservoir and second portion of the mixed phase sample to the separation column.

In some aspects, the techniques described herein relate to a method, further including: providing an ultrasonic component configured to receive a signal from the filtration component; and ultrasonically separating at least one component of the second portion of the mixed phase sample in the separation column.

In some aspects, the techniques described herein relate to a method, further including: providing a rotatable selection component configured to communicate with the separation column via a feedback signal, and configured to provide a first assay configured to extract a first target and a second assay configured to extract a second target, wherein the rotatable selection component is configured to communicate the mixed phase sample from the separation column to a second reservoir component; signaling the rotatable selection component based on the feedback signal from the separation column; rotating the rotatable selection component; selecting the first assay; extracting the first target; rotating the rotatable selection component; selecting the second assay; extracting the second target; and transferring the first and second targets to the second reservoir component.

In some aspects, the techniques described herein relate to a method, further including: providing a feedback module configured to communicate the first and second targets in the second reservoir component to the distribution component further including a target container and a feedback loop configured to communicate the second reservoir component with the spectrometer; transferring the first target from the second reservoir component to the target container; transferring the second target from the second reservoir component to the feedback loop; analyzing the second target via the spectrometer; filtering and separating the second target via the filtration component; and communicating a first portion of the second target to the sample reservoir, and a second portion of the second target to the separation column.

Embodiments include one, more, or any combination of the various apparatuses and methods described herein. Other features and advantages of the present disclosure will become apparent from the following more detailed description, taken in conjunction with the accompanying, which illustrate, by way of example, the principles of the disclosure.

### BRIEF DESCRIPTION OF THE DRAWINGS

FIG. 1 illustrates a perspective view of a Sample Analysis System, according to embodiments of the present disclosure.

FIG. 2 illustrates a flow diagram for a method of purifying a mixed phase sample, according to embodiments of the present disclosure.

FIG. 3 illustrates a perspective view of a Sample Analysis System according to embodiments of the present disclosure.

FIG. 4 illustrates a side elevation view of a Sample Analysis System according to embodiments of the present disclosure.

FIG. 5 illustrates a perspective view of a Sample Analysis System according to embodiments of the present disclosure.

FIG. 6 illustrates a side elevation view of a Sample Analysis System according to embodiments of the present disclosure.

FIG. 7 illustrates a perspective view of a Sample Analysis System according to embodiments of the present disclosure.

FIG. 8 illustrates a system for purifying a mixed phase sample according to embodiments of the present disclosure.

FIG. 9 illustrates a perspective view of a Sample Analysis System according to embodiments of the present disclosure.

Corresponding reference characters indicate corresponding parts throughout the several views.

While the disclosure is amendable to various modifications and alternative forms, specific embodiments have been shown by way of example in the drawings and are described in detail below. The intention, however, is not to limit the disclosure to the particular embodiments described. On the contrary, the disclosure is intended to cover all modifications, equivalents, and alternatives falling within the scope of the disclosure as defined by the appended claims.

### DETAILED DESCRIPTION

The following detailed description illustrates embodiments of the disclosure and manners by which they can be implemented. Although the best mode of carrying out the present disclosure has been disclosed, those skilled in the art would recognize that other embodiments for carrying out or practicing the present disclosure are also possible.

It should be noted that the terms “first,” “second,” and the like, herein do not denote any order, quantity, or importance, but rather are used to distinguish one element from another. Further, the terms “a” and “an” herein do not denote a limitation of quantity, but rather denote the presence of at least one of the referenced item.

Purification and isolation of elements, materials and microorganisms in a bulk, windborne or otherwise on-site collected sample requires significant assay therefore, an automatically adaptable system is described herein. The automatically adaptable system is configured for the analysis of any sample regardless of the on-site sample selection technique, or properties of the sample. A chain process of identification, extraction, purification, and selection of appropriate assays affected by the measurements made by initial measurements of the system can accomplish purification and isolation of the sub-components of the sample.

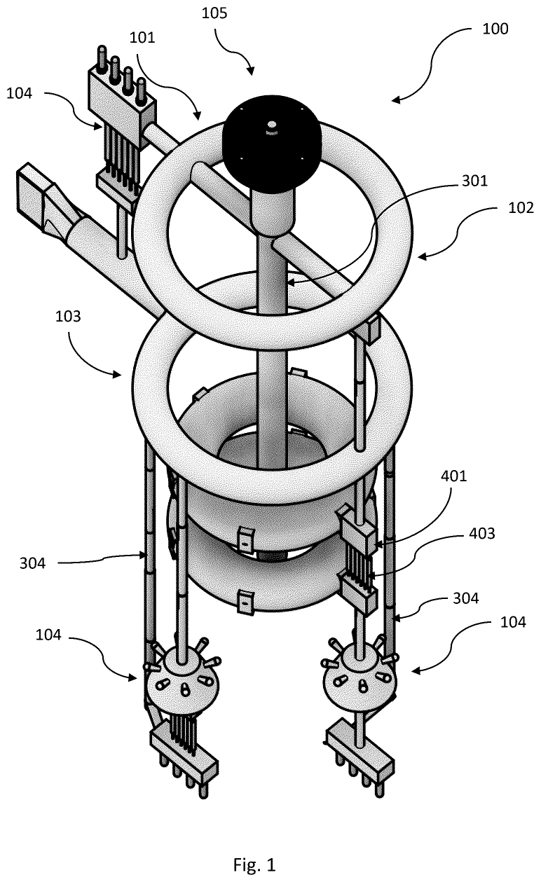

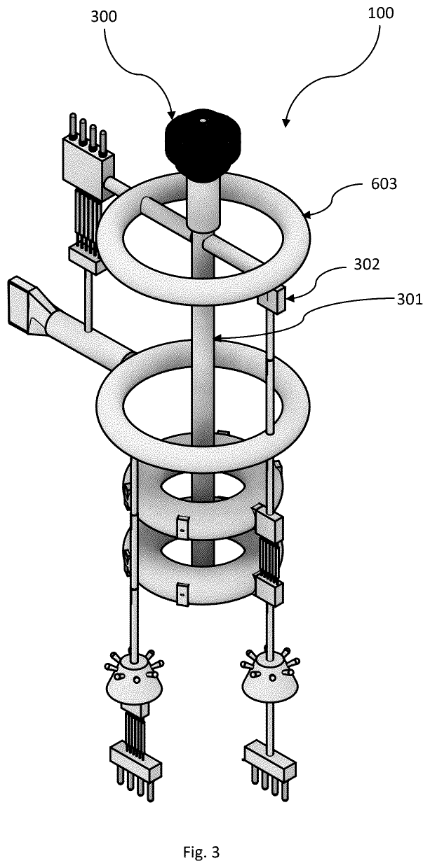

As shown in FIGS. 1-7, the techniques described herein relate to a system for analysis of a sample (SAS). The SAS 100 can comprise an analysis module 101 configured to perform a cycle of operations. The analysis module 101, according some embodiments, is configured to accommodate a sample and isolate various thermodynamic phase of the sample, chemical structures, and properties thereof. The cycle of operations performed by the analysis module 101 can include: (a) selecting a phase analyte of the sample in a phase module 102, (b) identifying a target product from the phase analyte in a component module 103, and (c) extracting the target product from the phase analyte in one or more extraction modules 104; a device 105 configured to interface with the analysis module 101 and including a processor configured to activate one or more of extraction modules 104 during a cycle of operations a)-c), wherein the one or more extraction modules 104 are configured to reduce phase analyte purity to between 85%-90% during the cycle of operations a)-c).

In some cases, according to embodiments of the present disclosure the analysis module 101 can include the following assays, includes, but it not limited to the following assays: Atomic Absorption Spectrometer, Atomic and Optical Emission Spectrometer, Benchtop NMR Spectrometers, Electrochemical Analysis, Electron paramagnetic resonance, Elemental Analyzers, Fluorescence Spectrometers, Fourier Transform Isotope Spectrometer, Fourier Transform Near-Infrared (FT-NIR) Spectrometers, Grabner flash point detection, Gas analyzers, Gas chromatograph, Gel Permeation Chromatography, Raman Analysis, X-Ray Fluorescence Analyzer, Hyperspectral imaging and sensing, lon Chromatography, Mass Spectrometer, NMR spectroscopy Analyzer, Pharmaceutical Analysis Equipment, Secondary lon Mass Spectrometry, Vapor Pressure Measurements, X-Ray and Gamma Ray Detectors, C-Ray Diffractometers, X-Ray Fluorescence Analyzers, X-ray Optics, X-Ray Photoelectron Spectroscopy, and XRF Spectrometer.

In some aspects, the techniques described herein relate to a SAS 100 that is capable of being integrated into a portable housing and connected to a photovoltaic solar array system. In some cases, the SAS 100 may be configured to operated remotely via connection with a wireless network. In some cases, the SAS 100 can be utilized to analyze particulate accumulated on the surface of a photovoltaic panel 703.

In some aspects, the techniques described herein relate to a system wherein the processor is configured to activate the component module 103, wherein the component module 103 is configured to identify a chemical component of the target product.

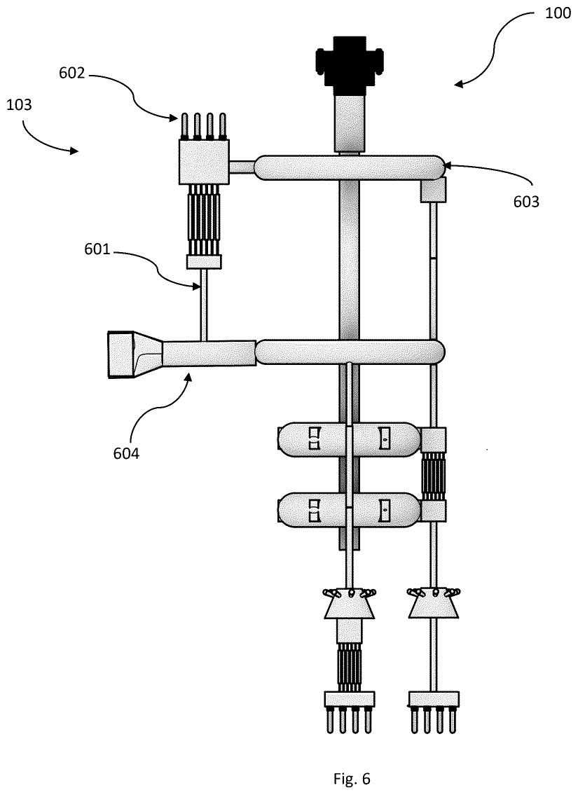

As shown in FIG. 6, In some aspects, the techniques described herein relate to a SAS 100 wherein the component module 103 includes a pressure gradient tube 601, and is configured to control transport of the chemical component from a collection chamber 602 to a first chemical identification component 603. In some cases, the pressure gradient tube 601, can comprise a peristaltic pump.

In some aspects, the techniques described herein relate to a SAS 100 wherein the processor is configured to receive a feedback signal from the first chemical identification component 603, and adjust the component module 103 to control transport to a second chemical identification component 604 based on the feedback signal.

In some aspects, the techniques described herein relate to a SAS 100 wherein the processor is configured to activate the phase module 102, wherein the phase module 102 is configured to identify a thermodynamic phase of the sample.

In some aspects, the techniques described herein relate to a SAS 100 wherein the processor is configured to receive a feedback signal from the phase module 102 and activate the one or more extraction modules 104 based on the feedback signal.

In some aspects, the techniques described herein relate to a SAS 100 wherein the processor is configured to receive a feedback signal from the analysis module and activate a recycling module configured to control transport of the target product to a storage component based on the feedback signal from the analysis module. In some case embodiment herein disclosed include a computing device system configured to communicate and transmit signals between various elements herein.

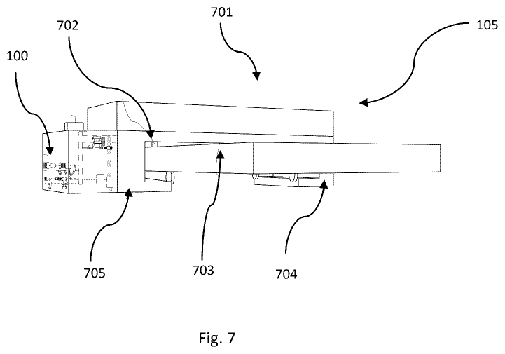

As shown in FIG. 7, in some aspects, the techniques described herein relate to a SAS 100 wherein the device 105 further includes a photovoltaic cleaning module 701 including of a scrubber 702 configured to move a across a photovoltaic panel 703, a fluid delivery element 704, and a sample collection element 705, wherein the sample collection element 705 is configured to communicate with the analysis module 101 to control the analysis of the sample.

In some cases, the SAS 100 is configured to couple with a photovoltaic panel 703 such that the SAS 100 is powered via an electrical component connection to a solar array. In some cases, the electrical component connection can comprise a voltage input which is configured to receive an output voltage from a solar array. In some cases, the solar array is at least one photovoltaic panel. The electrical component connection may further include a maximum power point tracking (MPPT) inverter, wherein the MPPT inverter can receive the output voltage from the solar array, whereby the MPPT inverter is also configure to deliver a solar voltage to a battery charger, a battery charge controller, and a battery bank.

In some cases, the battery charger is configured to communicate with the battery bank, wherein the battery charge controller is configured to deliver a charge profile to the battery bank based on a user input. The user input can comprise a set point voltage, float voltage, bulk charge voltage, and disconnect voltage. In some cases, the user input controls the delivery of power to the battery bank.

According to embodiments of the present disclosure, the battery bank can consist, but is not limited to: of LifePO4 batteries, Absorption Glass Matt (AGM) batteries, Lead-Acid batteries, Lithium-Ion batteries, and/or water-activated batteries.

According to embodiments of the present disclosure the battery bank deliver power to the SAS 100 to enable operation of the SAS 100. In some embodiments, the battery bank can be configured to activate upon rainfall in the location of the photovoltaic panel 703, whereby water collected from the surface of the photovoltaic panel 703 can activate the photovoltaic cleaning module 701, via a precipitation sensor configured to measure relative humidity, temperature, and dewpoint and estimate precipitation total.

In some cases, the photovoltaic cleaning module 701 can be rain-activated, wherein the photovoltaic cleaning module 701 receives a signal from the precipitation sensor and then the cleaning module 701 sends a signal to the scrubber 702, wherein the scrubber 702 moves across the surface of the photovoltaic panel 703 and delivers debris scrubbed off the surface of the photovoltaic panel 703 into the sample collection element 705.

In some cases, the sample collection element 705 transmits debris collected via the scrubber 702 from the photovoltaic panel 703 to the SAS 100, whereby the debris is analyzed using the SAS 100.

As shown in FIGS. 1, 3-6, in some aspects, the techniques described herein relate to a SAS 100 for analyzing a mixed phase sample that can include a distribution component 301 which may be a distribution network of piping that can facilitate the movement of a sediment in-situ of a liquid, and/or gas sample provided to the sample inlet 300. The first chemical identification component 603 may further include a spectrometer module 302, wherein the distribution component 301 is configured to accommodate the mixed phase sample and configured to transmit a signal to a central processing unit, wherein the central processing unit is configured to send an operational signal to the distribution component 301 based on the signal from the spectrometer module 302, wherein the distribution component 301 can be configured to transfer the mixed phase sample from a sample inlet 300 to a filtration component 401 based on the operational signal.

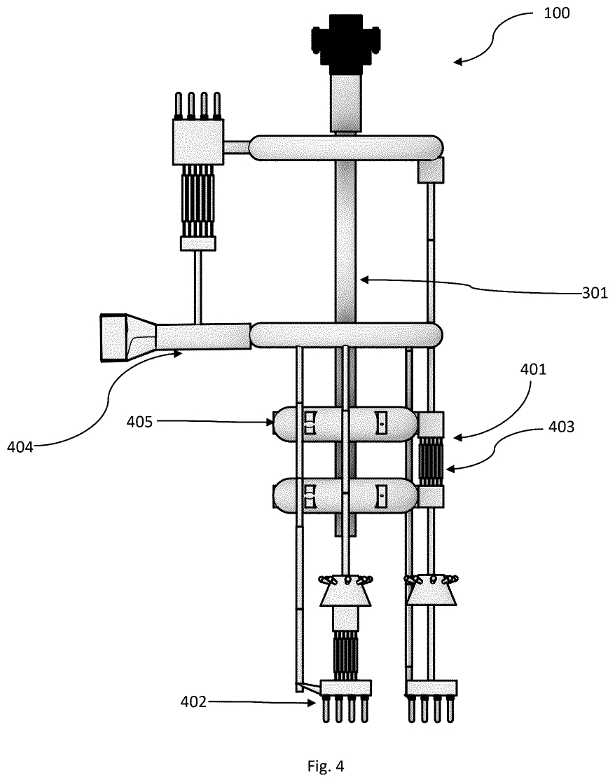

As shown in FIGS. 1 and 4 in some aspects, the techniques described herein relate to a SAS 100, wherein the filtration component 401 is configured to communicate with a sample reservoir 402 component configured to accommodate at a least a first portion of the mixed phase sample, the filtration component 401 is configured to communicate with a separation column 403 at least a second portion of the mixed phase sample.

In some cases, the sample reservoir 402 can be configured to communicate with a rotatable selection component 405, wherein the rotatable selection component 405 is configured to communicate with the central processing unit, based on a signal from the extraction module 104, wherein the rotatable selection component 405 is configured to communicate with the sample reservoir having a phase-specific storage subcomponent, e.g., gas, liquid, and solid.

In some cases, the separation column 403 can be configured to communicate with a rotatable selection component 405, wherein the rotatable selection component 405 is configured to communicate with the central processing unit, based on a signal from the extraction module 104, wherein the rotatable selection component 405 is configured to communicate with the separation column 403 having a phase-specific separation subcomponent, e.g., gas, liquid, and solid.

In some aspects, as shown in FIG. 4 the techniques described herein relate to a SAS 100, wherein the distribution component 301 further includes an ultrasonic component configured to receive a feedback signal from the filtration component 401 and activate an ultrasonic extraction module 404 based on the feedback signal from the filtration component 401.

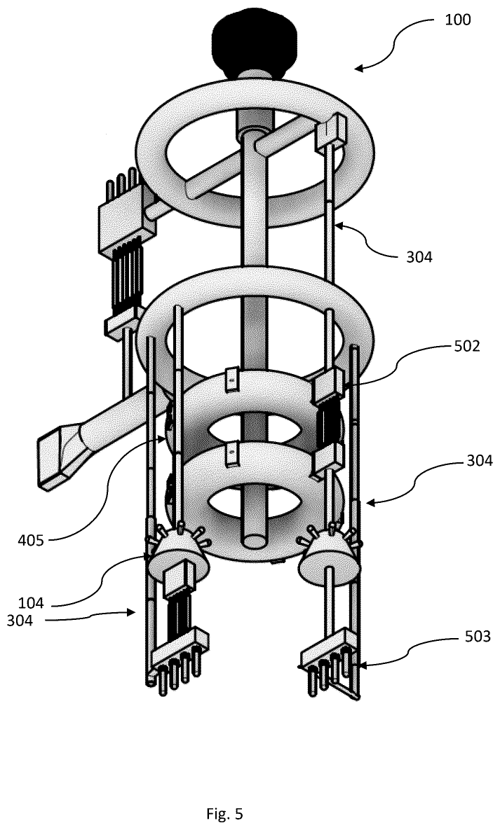

As shown in FIG. 5 in some aspects, the techniques described herein relate to SAS 100, further including a purification module 501, wherein the feedback signal received by the central processing unit from the spectrometer module 302 controls operation of the purification module 501 which is configured to communicate with the sample reservoir component.

As shown in FIGS. 1, 3-6 in some aspects, the techniques described herein relate to a SAS 100, wherein the distribution component 301 further includes a rotatable selection component 405 configured to communicate with the separation column 403 further configured to produce a feedback signal, and based on the feedback signal from the separation column 403, a rotatable selection component 405 selectively rotates a rotatable portion of the analysis module 101, wherein the second portion of the mixed phase sample is communicated from the separation column 403 to the rotatable selection component 405.

In some cases, the rotatable selection component 405, can be configured to include any of the assays included in the SAS 100. The rotatable selection component 405 accommodates the ability of the SAS 100 to make measurements of the mixed phase sample and identify the chemical components and physical properties thereof.

As shown in FIG. 5 in some aspects, the techniques described herein relate to a SAS 100, wherein the rotatable selection component 405 further includes an analyzer 502, the analyzer 502 being configured to isolate a specific component from the second portion of the mixed phase sample, and communicate the specific component to a second reservoir component 503.

In some aspect, the rotatable selection component 405 further includes a gravitational force factor. Various aspects of the rotatable selection component, including but not limited to, the analyzer 502, can be configured to be rotated at a pre-determined velocity. This predetermined velocity can be selected by a user, or the output of the central processing unit, such that the rotatable selection component is configured to, separate materials phases of the mixed phase sample.

In some aspects, the techniques described herein relate to a SAS 100, wherein the analyzer 502 is further configured to communicate a remainder of the mixed phase sample to the filtration component via the distribution component 301 further including a feedback loop 304 configured to communicate the remainder of the mixed phase sample from the analyzer 502 to the filtration component.

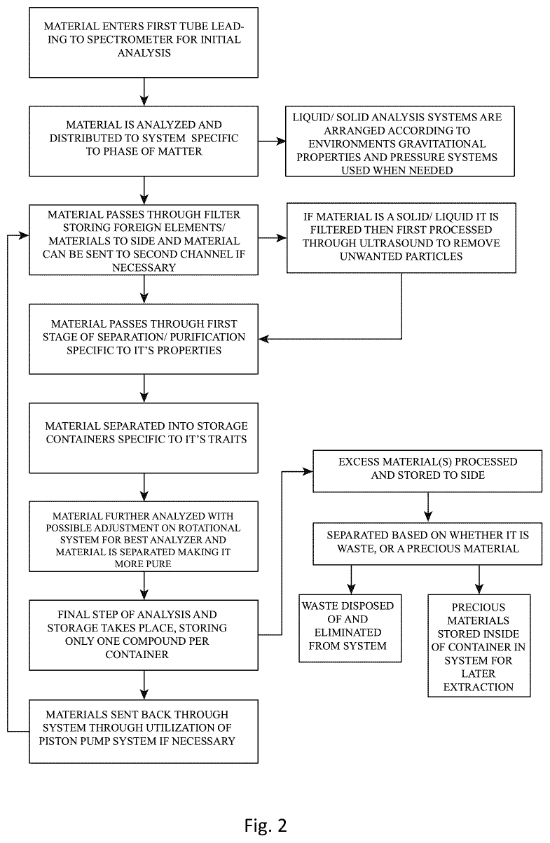

As shown in FIG. 2 in some aspects, the techniques described herein relate to a Method for purifying a mixed phase sample including: providing a central processing unit configured to communicate and control a distribution component 301 including: a sample inlet 300, a spectrometer module 302, and a filtration component 401, a sample reservoir 402, and a separation column 403; transferring the mixed phase sample from the sample inlet 300 to the spectrometer module 302; analyzing the mixed phase sample via the spectrometer module 302; filtering and separating the mixed phase sample via the filtration component 401; and communicating a first portion of the mixed phase sample to the sample reservoir 402 and second portion of the mixed phase sample to the separation column 403.

In some aspects, the techniques described herein relate to a method, further including: providing an ultrasonic extraction module 404 configured to receive a signal from the filtration component 401; and ultrasonically separating at least one component of the second portion of the mixed phase sample in the separation column 403.

In some aspects, as shown in FIG. 2, the techniques described herein relate to a method, further including: providing a rotatable selection component 405 configured to communicate with the separation column 403 via a feedback signal, and configured to provide a first assay configured to extract a first target and a second assay configured to extract a second target, wherein the rotatable selection component 405 is configured to communicate the mixed phase sample from the separation column 403 to a second reservoir component 503; signaling the rotatable selection component 405 based on the feedback signal from the separation column 403; rotating the rotatable selection component 405; selecting the first assay; extracting the first target; rotating the rotatable selection component 405; selecting the second assay; extracting the second target; and transferring the first and second targets to the second reservoir component 503.

In some aspects, the techniques described herein relate to a method, further including: providing a feedback module configured to communicate the first and second targets in the second reservoir component 503 to the distribution component 301 further including a target container 406 and a feedback loop 304 configured to communicate the second reservoir component 503 with the spectrometer module 302; transferring the first target from the second reservoir component 503 to the target container 406; transferring the second target from the second reservoir component 503 to the feedback loop via the distribution component 301; analyzing the second target via the spectrometer module 302; filtering and separating the second target via the filtration component 401; and communicating a first portion of the second target to the sample reservoir 402, and a second portion of the second target to the separation column 403.

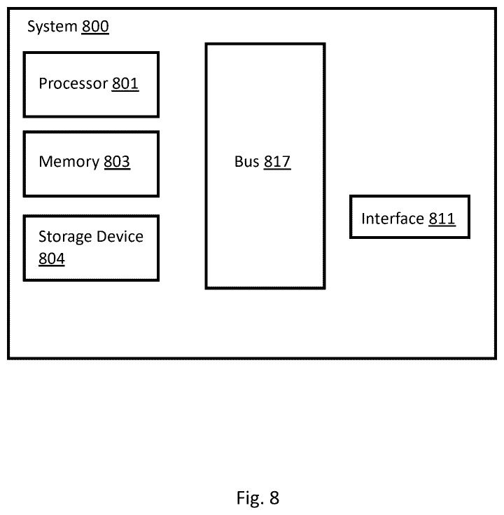

FIG. 8 illustrates one example of a computing device system 800, configured in accordance with one or more embodiments. According to various embodiments, a computing device system 800 suitable for implementing embodiments described herein includes a processor 801, a memory module 803, a storage device 805, an interface 811, and a bus 815 (e.g., a PCI bus or other interconnection fabric.) Computing device system 800 may operate as variety of devices such as an application server, a database server, or any other device or service described herein. Although a particular configuration is described, a variety of alternative configurations are possible. The processor 801 may perform operations such as those described herein. Instructions for performing such operations may be embodied in the memory bank 803, on one or more non-transitory computer readable media, or on some other storage device. Various specially configured devices can also be used in place of or in addition to the processor 801. The interface 811 may be configured to send and receive data packets over a network. Examples of supported network interfaces include, but are not limited to: Ethernet, fast Ethernet, Gigabit Ethernet, frame relay, cable, digital subscriber line (DSL), token ring, Asynchronous Transfer Mode (ATM), High-Speed Serial Interface (HSSI), and Fiber Distributed Data Interface (FDDI). These interfaces may include ports appropriate for communication with the appropriate media. They may also include an independent processor and/or volatile RAM. A computer system or computing device may include or communicate with a monitor, printer, or other suitable display for providing any of the results mentioned herein to a user.

According to some embodiments, the SAS 100 may be configured to record a time variable associated with the collection of samples. In some cases, the SAS 100 may use a computing device system to communicate and record a location variable, time variable, and weather variables such as humidity, windspeed, and atmospheric pressure. In some cases, the SAS 100 and the computing device system are configured to communicate with a laser engraving mechanism enabled to engrave a Quick Response (QR) code onto a surface of at least the sample reservoir 402, and or the second reservoir component 503.

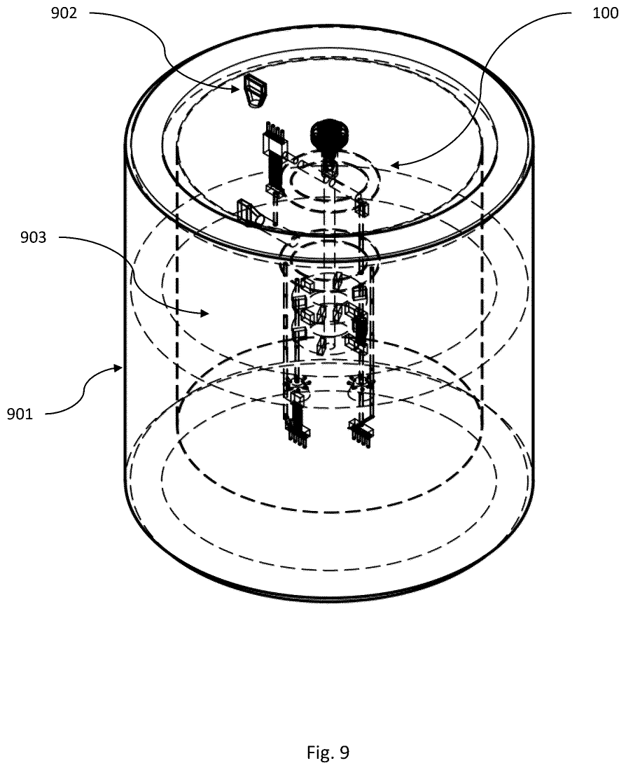

FIG. 9 Illustrates a housing 901 configured to enclose the SAS 100, according to some embodiments. In some cases, the SAS 100 can be configured for the temperature control and pressure control via the housing 901 and the computing device system 800. In some cases, the housing 901 can include an external pressure control element 902 configured to regulate pressure between an interior of the housing 901 and the exterior. In some cases, the housing 901 can be configured to thermodynamically insulate the interior 903 of the housing 901 from the exterior. In some cases, the housing 901 is configured to enable the SAS 100 for rotational movement so that the housing 901 can generate rotational gravity forces creating a microgravity environment.

The examples mentioned above are merely used for illustrative purposes and not meant to be limitations of the present disclosure. Furthermore, the approaches in various embodiments of the present disclosure are implemented according to the universal conversion method and related circuitry provided by the embodiments of the present disclosure.

What is claimed is:

1) A system for automatically and remotely collecting and analyzing one or more mixed phase samples over time comprising:
an analysis module comprising a phase module comprising a Raman spectrometer; configured to perform a cycle of operations comprising:
a) Selecting a phase analyte of the sample in the phase module,
b) Identifying a target product from the phase analyte in a component module comprising a gas chromatograph, and
c) Extracting the target product from the phase analyte in one or more extraction modules comprising a gel permeation chromatograph;
a device configured to interface with the analysis module and comprising a processor configured to activate one or more of extraction modules during a cycle of operations a)-c),
wherein the one or more extraction modules are configured to reduce phase analyte purity to 85% during the cycle of operations a)-c).

2) The system of claim 1, wherein the processor is configured to activate the component module, wherein the component module is configured to identify a chemical component of the target product.

3) The system of claim 2, wherein the component module comprises a distribution component comprising a pressure gradient tube, and is configured to control transport of the chemical component from a collection chamber to a chemical identification component.

4) The system of claim 3 wherein the processor is configured to receive a feedback signal from the chemical identification component, and adjust the component module to control transport to a second chemical identification component based on the feedback signal.

5) The system of claim 1 wherein the processor is configured to activate the phase module, wherein the phase module configured to identify a thermodynamic phase of the sample.

6) The system of claim 5 wherein the processor is configured to receive a feedback signal from the phase module and activate the one or more extraction modules based on the feedback signal.

7) The system of claim 1 wherein the processor is configured to receive a feedback signal from the analysis module and activate a recycling module configured to control transport of the target product to a storage component based on the feedback signal from the analysis module.

8) The system of claim 7 wherein the device further includes a photovoltaic cleaning module comprising of a scrubber configured to move across an external plane of a photovoltaic panel along one or more axes, a fluid delivery element configured to deliver a fluid to the photovoltaic panel, and a sample collection element configured to collect one or more samples, wherein the sample collection element is configured to receive the one or more samples and communicate with the analysis module to control the analysis of the one or more samples.

9) A system for automatically and remotely analyzing a mixed phase sample comprising:
a distribution component comprising a spectrometer module, wherein the distribution component is configured to accommodate a mixed phase sample inlet and configured to transmit a signal to a central processing unit, wherein the central processing unit is configured to send an operational signal to the distribution component based on the signal from the spectrometer module, wherein the distribution component is configured to transfer the mixed phase sample from a sample inlet to a filtration component based on the operational signal.

10) The system of claim 9, wherein the filtration component is configured to communicate with a sample reservoir component configured to accommodate at a least a first portion of the mixed phase sample, the filtration component is configured to communicate with a separation column at least a second portion of the mixed phase sample.

11) The system of claim 10, wherein the distribution component further comprises an ultrasonic component configured to receive a feedback signal from the filtration component and activate an ultrasonic extraction module based on the feedback signal from the filtration component.

12) The system of claim 11, further comprising a purification module, wherein the feedback signal received by the central processing unit from the spectrometer module controls operation of the purification module which is configured to communicate with the sample reservoir component.

13) The system of claim 12, wherein the distribution component further comprises a rotatable selection component configured to communicate with the separation column further configured to produce a feedback signal, and based on the feedback signal from the separation column, a rotatable selection column selectively rotates a rotatable portion of the distribution component, wherein the second portion of the mixed phase sample is communicated from the separation column to the rotatable selection component.

14) The system of claim 13, wherein the rotatable selection component further comprises an analyzer, the analyzer being configured to isolate a specific component from the second portion of the mixed phase sample, and communicate the specific component to a second reservoir component.

15) The system of claim 14, wherein the analyzer is further configured to communicate a remainder of the mixed phase sample to the filtration component via the distribution component further comprising a feedback loop configured to communicate the remainder of the mixed phase sample from the analyzer to the filtration component.

16) A method for remotely and automatically purifying a mixed phase sample comprising:
providing a central processing unit configured to communicate and control a distribution component comprising: a sample inlet, a spectrometer, and a filtration component, a sample reservoir, and a separation column;
transferring the mixed phase sample from the sample inlet to the spectrometer;
analyzing the mixed phase sample via the spectrometer;
filtering and separating the mixed phase sample via the filtration component; and
communicating a first portion of the mixed phase sample to the sample reservoir and second portion of the mixed phase sample to the separation column.

17) The method of claim 16, further comprising:
providing an ultrasonic component configured to receive a signal from the filtration component; and
ultrasonically separating at least one component of the second portion of the mixed phase sample in the separation column.

18) The method of claim 17, further comprising:
providing a rotatable selection component configured to communicate with the separation column via a feedback signal, and configured to provide a first assay configured to extract a first target and a second assay configured to extract a second target, wherein the rotatable selection component is configured to communicate the mixed phase sample from the separation column to a second reservoir component;
signaling the rotatable selection component based on the feedback signal from the separation column;
rotating the rotatable selection component;
selecting the first assay;
extracting the first target;
rotating the rotatable selection component;
selecting the second assay;
extracting the second target; and
transferring the first and second targets to the second reservoir component.

19) The method of claim 18, further comprising:
providing a feedback module configured to communicate the first and second targets in the second reservoir component to the distribution component further comprising a target container and a feedback loop configured to communicate the second reservoir component with the spectrometer;
transferring the first target from the second reservoir component to the target container;
transferring the second target from the second reservoir component to the feedback loop;
analyzing the second target via the spectrometer;
filtering and separating the second target via the filtration component; and
communicating a first portion of the second target to the sample reservoir, and a second portion of the second target to the separation column.
